(19) United States
(12) Patent Application Publication
(10) Pub. No.: US 2017/0038883 A1
(43) Pub. Date: Feb. 9, 2017

(54) ELECTRONIC DEVICE WITH VALID SINGLE FINGER TOUCH DETECTION AND RELATED METHODS

(71) Applicant: STMICROELECTRONICS ASIA PACIFIC PTE LTD, Singapore (SG)

(72) Inventors: Mythreyi NAGARAJAN, Singapore (SG); Manivannan Ponnarasu, Singapore (SG)

(21) Appl. No.: 14/816,135

(22) Filed: Aug. 3, 2015

(51) Int. Cl. G06F 3/041; G06F 3/044

(52) U.S. Cl. CPC G06F 3/0416; G06F 3/044; G06F 3/0412

(57) ABSTRACT

An electronic device may include a touchscreen having an array of finger touch sensitive areas, and a controller coupled to the touchscreen. The controller is configured to read touch values from the array of finger touch sensitive areas, and determine when the read touch values define a valid single finger touch pattern having lower touch values within adjacent higher touch values, and, if so, treating the read touch values as being representative of a single finger touch, and, if not, causing a finger separation determination.

### TECHNICAL FIELD

The present disclosure relates to the field of electronic devices, and, more particularly, to electronic devices with touch input and related methods.

### BACKGROUND

Cellular communication systems continue to grow in popularity and have become an integral part of both personal and business communications. Cellular telephones allow users to place and receive phone calls most anywhere they travel. Moreover, as available cellular telephone technology has increased, so too has the functionality of cellular devices. For example, many cellular devices now incorporate Personal Digital Assistant (PDA) features such as calendars, address books, task lists, calculators, memo and writing programs, etc. These multi-function devices usually allow users to wirelessly send and receive electronic mail (email) messages and access the internet via a cellular network and/or a wireless local area network (WLAN), for example.

In the earliest cellular devices, the device included a numeric keyboard and small display for operation of the device. As cellular devices packaged more functionality therein, the typical numeric keypad gave way to the alphanumeric keypad, thereby allowing a user to readily enter full linguistic text. Another consequence of the expansion of cellular device functionality is the desire to increase display size and resolution. A typical tradeoff during design of cellular devices is the exchange of space between the display and the keypad. This design tradeoff may be more problematic as users demand smaller and lighter devices that are easier and more convenient to carry.

An approach to this design tradeoff is to include a touchscreen input in the cellular device. In other words, this approach leans the aforementioned design tradeoff greatly in favor of the display by removing the keypad entirely as an input device, thereby providing the user with a larger display. Recently, mobile device operating systems (OS's) now utilize multi-touch user input, i.e. recognizing a plurality of concurrent touch input points on the touchscreen, for certain functions, such as pinch-to-zoom.

Typically, an input to a touch screen is intended by the user when placing a finger or stylus on the screen causing the touch screen to generate a variety of signals to identify the location of the touch on the touch screen. Further, sometimes two or more touches are intended simultaneously so as to convey the intent for a specific navigation command, such as a zoom command within an application that is currently running or to close the application altogether. Thus, deciphering, via a dedicated touch screen algorithm, the intent of the user when a single touch or simultaneous touches are received is an important feature of any touch screen device.

The user scenarios may vary for such input devices. They may be handheld or operated by placing on different surfaces that may or may not be conductive or well-grounded electrically. And such factors, like the effects of electrical grounding of the system, complicate the deciphering of the touch inputs, especially for a large finger of a user when the device is in weak ground or isolated conditions.

### SUMMARY

An electronic device may comprise a touchscreen comprising an array of finger touch sensitive areas, and a controller coupled to the touchscreen. The controller is configured to read touch values from the array of finger touch sensitive areas, and determine when the read touch values define a valid single finger touch pattern having lower touch values within adjacent higher touch values, and, if so, treating the read touch values as being representative of a single finger touch, and, if not, causing a finger separation determination. Advantageously, the electronic device may accurately identify single-touch inputs.

More specifically, the controller may be configured to determine when the read touch values define the valid single finger touch pattern by at least determining when the higher touch values define a complete ring. Also, the controller may be configured to determine when the read touch values define an invalid single finger touch pattern by at least determining when the higher touch values define a partial ring. The controller may be configured to determine the partial ring based upon a first region of the array of finger touch sensitive areas having the lower touch values not lying completely within a second region of the array of finger touch sensitive areas having the higher touch values. The controller may be configured to determine the partial ring based upon corner areas of a first region of the array of finger touch sensitive areas having the lower touch values not lying completely within a second region of the array of finger touch sensitive areas having the higher touch values.

Additionally, the controller may be configured to not perform the finger separation determination when the read touch values define the valid single finger touch pattern. The electronic device may further comprise a processor and a memory coupled thereto, and the processor may be coupled to the controller. Each finger touch sensitive area of the array thereof may comprise a capacitive finger sensing pixel. For example, the electronic device may include a housing carrying the touchscreen and the controller.

Another aspect is directed to an electronic device comprising a processor and associated memory coupled thereto, and a display coupled to the processor. The display may include a touchscreen comprising an array of finger touch sensitive areas, and a controller coupled to the touchscreen and configured to read touch values from the array of finger touch sensitive areas. The controller may be configured to determine when the read touch values define a valid single finger touch pattern having lower touch values within adjacent higher touch values, and, if so, treating the read touch values as being representative of a single finger touch, and, if not, causing a finger separation determination.

Another aspect is directed to a method for operating an electronic device comprising a touchscreen having an array of finger touch sensitive areas, and a controller coupled thereto. The method may include operating the controller to read touch values from the array of finger touch sensitive areas, and operating the controller to determine when the read touch values define a valid single finger touch pattern having lower touch values within adjacent higher touch values, and, if so, treating the read touch values as being representative of a single finger touch, and, if not, causing a finger separation determination.

### BRIEF DESCRIPTION OF THE DRAWINGS

FIG. 1 is a schematic diagram of an electronic device, according to the present disclosure.

FIG. 2 is a flowchart illustrating a touch detection process of the electronic device of FIG. 1.

FIG. 3 is a schematic diagram of an ideal valid single finger touch pattern in the electronic device of FIG. 1.

FIG. 4 is a schematic diagram of example valid single finger touch pattern values in the electronic device of FIG. 1.

FIG. 5 is a diagram illustrating in three-dimensions the touch values in the example valid single finger touch pattern values of FIG. 4.

FIG. 6 is a schematic diagram of example invalid single finger touch pattern values in the electronic device of FIG. 1.

FIG. 7 is a diagram illustrating in three-dimensions touch values in an example single finger touch pattern in good grounding conditions.

FIG. 8 is a schematic diagram of example valid single finger touch pattern values of the single finger touch pattern of FIG. 7.

FIG. 9 is a diagram illustrating in three-dimensions touch values in the example valid single finger touch pattern of FIG. 6.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and prime notation is used to indicate similar elements in alternative embodiments/examples.

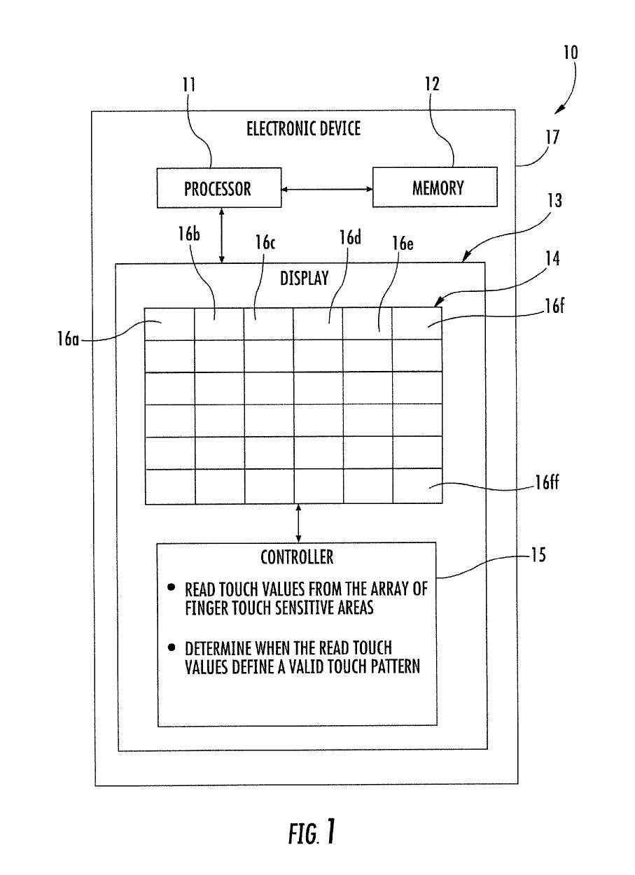

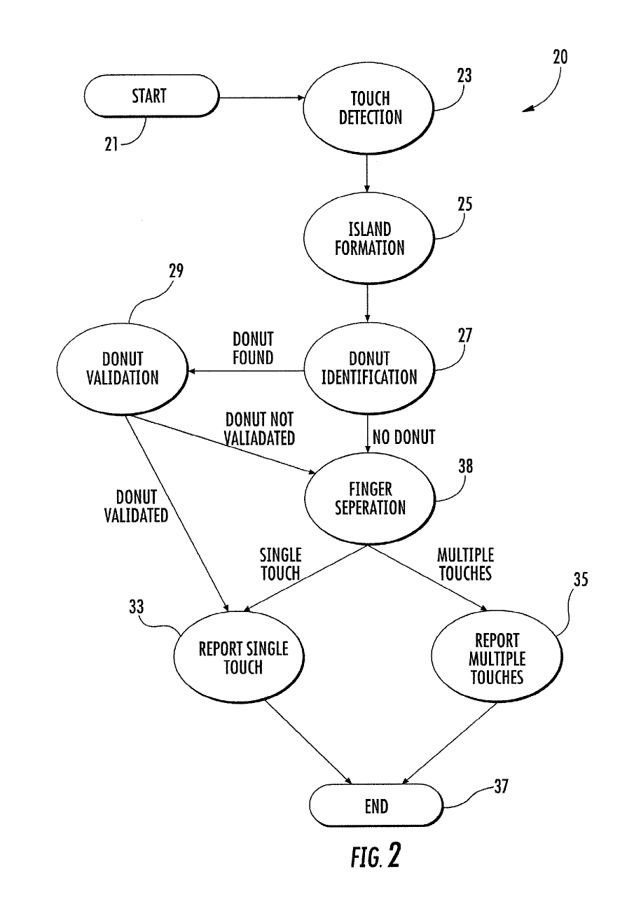

Referring to FIGS. 1-3, an electronic device 10 according to the present disclosure is now described. Also, a flowchart 20 illustrates operation of the electronic device 10, and begins at Block 21. The electronic device 10 illustratively includes a processor 11 and associated memory 12 coupled to the processor (e.g. multi-core system on chip device). The electronic device 10 illustratively includes a display (e.g. liquid crystal display, organic light emitting diode display) 13 coupled to the processor 11.

The display 13 illustratively includes a touchscreen 14 comprising an array of finger touch sensitive areas 16a-16ff, and a controller 15 coupled to the touchscreen and configured to read touch values from the array of finger touch sensitive areas. In some embodiments, each finger touch sensitive area 16a-16ff of the array of finger touch sensitive areas may comprise a capacitive finger sensing pixel. In the illustrated embodiment, the electronic device 10 illustratively includes a housing 17 carrying the display 13, the processor 11, and the memory 12.

The controller 15 is configured to receive the read touch values from the touchscreen 14 (Block 23). Once the read touch values are ingested, the controller 15 is configured to form the read touch values into groupings of rings (partial and complete rings) or islands (Block 25). In this step, the controller 15 is searching for groupings of interconnected nodes/finger touch sensitive areas 16a-16ff with positive strength values greater than a first threshold.

Referring to FIG. 3 and a diagram 30′ therein, the controller 15 is configured to determine when the read touch values (i.e. the identified rings) define a valid single finger touch pattern having lower touch values 31′ within adjacent higher touch values 32′, and, if so, treating the read touch values as being representative of a single finger touch (Blocks 27, 29, 33, 37), and, if not, causing and/or performing a finger separation determination (Blocks 38, 33, 35, 37). In some embodiments, the finger separation determination is alternatively or additionally performed by the processor 11 and/or software functionality of an onboard OS of the electronic device 10.

In diagram 30′, the identified valid single finger touch pattern is ideal (i.e. representing a large finger tip of a user in a weak grounding condition) and includes the lower touch values 31′ centered within the higher touch values 32′. Additionally, the controller 15 is configured to not perform the finger separation determination when the read touch values define the valid single finger touch pattern (Blocks 27, 29, 33, 37).

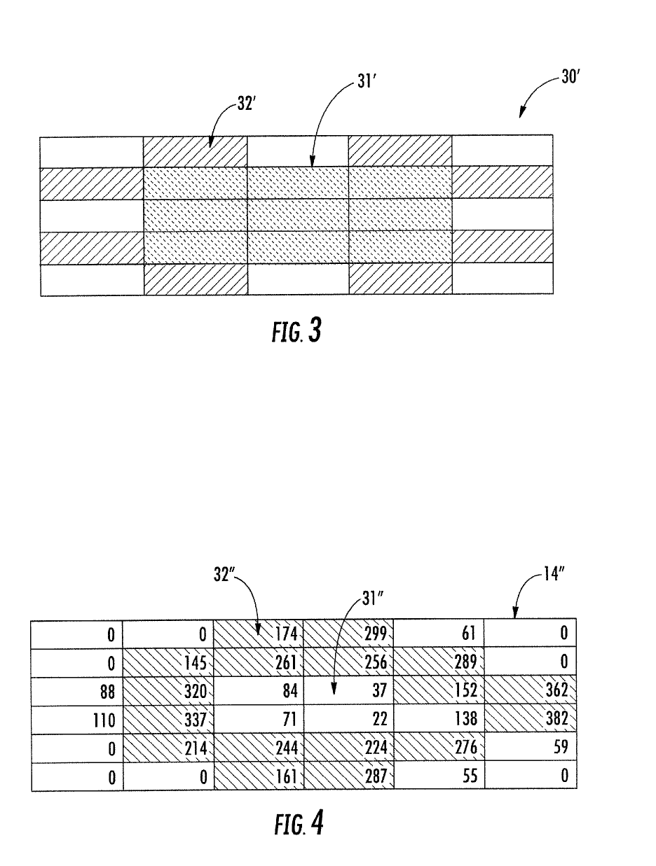

In typical prior art approaches, the identified valid single finger touch pattern would be subject to the finger separation determination, which may wrongly characterize the input (from the large fingertip of the user) as a multi-touch (multi-finger) input. Indeed, under weak ground conditions, the finger touch pattern of the single large finger appears similar to the finger touch pattern shown in FIG. 4. Advantageously, the electronic device 10 recognizes the large finger input as a single finger input.

The controller 15 is configured to determine when the read touch values define the valid single finger touch pattern by at least determining when the higher touch values 32′ define a complete ring or donut (Blocks 29, 33). In particular, the corners of the lower touch values 31′ have outer vertical and horizontal neighbors that are part of the higher touch values 32′. In other words, the controller 15 is searching for the large finger island having the shape of the ring/donut (strong positive nodes/finger touch sensitive areas 16a-16ff along the edges surrounding a hollow region of either small positive or negative nodes). If a sub-island of small positive/negative nodes lays completely within (i.e. the x-y boundaries of the small island are completely inside the x-y boundaries of the big island) the strong positive island, then it is marked as a ring or donut island pending validation.

For example, FIGS. 4-5 include exemplary read touch values from the array of finger touch sensitive areas 16a-16ff. Each finger touch sensitive area 16a-16ff illustratively includes a numerical value representing the contact value. Here, the lower touch values 31″ are completely surrounded by the higher touch values 32″. In this embodiment, the controller 15 defines the lower touch values 31″ as finger touch sensitive areas 16a-16ff with contact values less than the first threshold, and the controller defines the higher touch values 32″ as finger touch sensitive areas 16a-16ff with contact values greater than a second threshold. The first and second thresholds may be the same, or the first threshold may be alternatively less than the second threshold. In this example, the first and second thresholds both equal 140. Diagram 40″ provides a three-dimensional representation of the exemplary read touch values from the array of finger touch sensitive areas 16a-16ff.

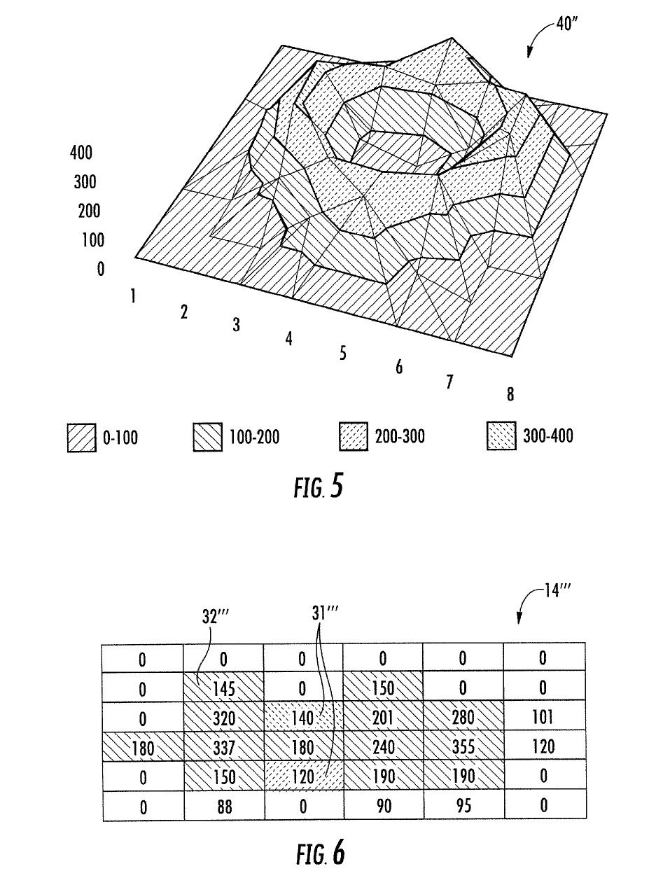

Referring additionally to FIGS. 6 and 9, the controller 15 is configured to determine when the read touch values define an invalid single finger touch pattern (i.e. not representing a large finger tip of the user) by at least determining when the higher touch values define a partial ring (Blocks 29, 38). The controller 15 is configured to determine the partial ring based upon a first region 31′″ of the array of finger touch sensitive areas 16a-16ff having the lower touch values not lying completely within a second region 32′″ of the array of finger touch sensitive areas having the higher touch values (Blocks 29, 38). The controller 15 is configured to determine the partial ring based upon corner areas of the first region 31′″ of the array of finger touch sensitive areas 16a-16ff having the lower touch values not lying completely within the second region 32′″ of the array of finger touch sensitive areas having the higher touch values (Blocks 29, 38, 37). In this particular example, the first region 31′″ is split between two separate finger touch sensitive areas that are outside of the second region 32′″. Also, the corners of the first region 31′″ do not each have vertical and horizontal outer neighbors in the second region 32′″. Diagram 50 provides a three-dimensional representation of the exemplary read touch values from the array of finger touch sensitive areas 16a-16ff. In this instance, the user's is applying two separate fingers. Correctly, the controller 15 is configured to determine the read touch values from FIGS. 6 and 9 as an invalid single finger touch pattern

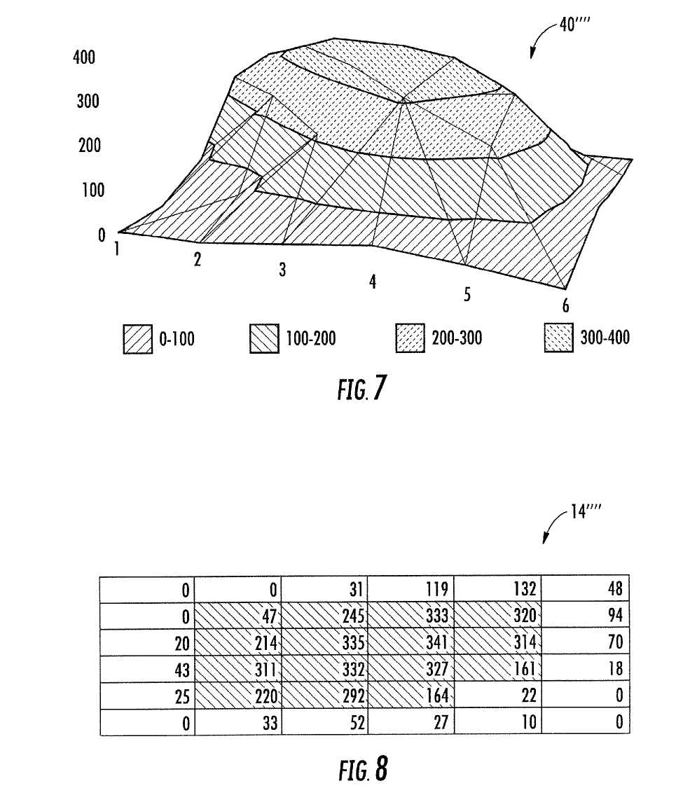

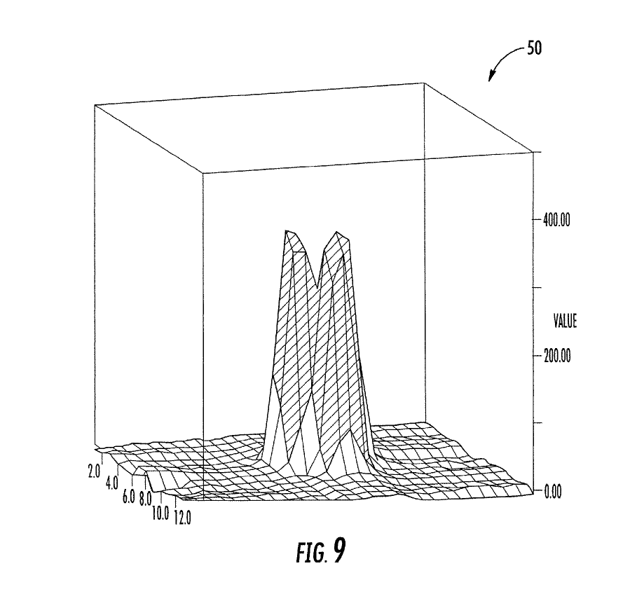

Referring now additionally to FIGS. 7-8, diagram 40″″ provides a three-dimensional representation of the exemplary read touch values from the array of finger touch sensitive areas 16a-16ff. In this instance, the electronic device 10 in a well grounded electrical environment, the user's large finger is properly registered as shown with associated values in the touchscreen 14″″.

Another aspect is directed to a method for operating an electronic device 10 comprising a touchscreen 14 having an array of finger touch sensitive areas 16a-16ff, and a controller 15 coupled to the array. The method may include operating the controller 15 to read touch values from the array of finger touch sensitive areas 16a-16ff, and operating the controller to determine when the read touch values define a valid single finger touch pattern having lower touch values within adjacent higher touch values, and, if so, treating the read touch values as being representative of a single finger touch, and, if not, performing a finger separation determination.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. An electronic device comprising:
a touchscreen comprising an array of finger touch sensitive areas; and
a controller coupled to said touchscreen and configured to
read touch values from the array of finger touch sensitive areas, and
determine when the read touch values define a valid single finger touch pattern having lower touch values within adjacent higher touch values, and, if so, treating the read touch values as being representative of a single finger touch, and, if not, causing a finger separation determination.

2. The electronic device of claim 1 wherein said controller is configured to determine when the read touch values define the valid single finger touch pattern by at least determining when the higher touch values define a complete ring.

3. The electronic device of claim 1 wherein said controller is configured to determine when the read touch values define an invalid single finger touch pattern by at least determining when the higher touch values define a partial ring.

4. The electronic device of claim 3 wherein said controller is configured to determine the partial ring based upon a first region of the array of finger touch sensitive areas having the lower touch values not lying completely within a second region of the array of finger touch sensitive areas having the higher touch values.

5. The electronic device of claim 3 wherein said controller is configured to determine the partial ring based upon corner areas of a first region of the array of finger touch sensitive areas having the lower touch values not lying completely within a second region of the array of finger touch sensitive areas having the higher touch values.

6. The electronic device of claim 1 wherein said controller is configured to not perform the finger separation determination when the read touch values define the valid single finger touch pattern.

7. The electronic device of claim 1 further comprising a processor and a memory coupled thereto; and wherein the processor is coupled to the controller.

8. The electronic device of claim 1 wherein each finger touch sensitive area of the array thereof comprises a capacitive finger sensing pixel.

9. The electronic device of claim 1 further comprising a housing carrying the touchscreen and the controller.

10. An electronic device comprising:
a processor and associated memory coupled thereto; and
a display coupled to said processor and comprising
a touchscreen comprising an array of finger touch sensitive areas, and
a controller coupled to said touchscreen and configured to
read touch values from the array of finger touch sensitive areas, and
determine when the read touch values define a valid single finger touch pattern having lower touch values within adjacent higher touch values, and, if so, treating the read touch values as being representative of a single finger touch, and, if not, causing a finger separation determination.

11. The electronic device of claim 10 wherein said controller is configured to determine when the read touch values define the valid single finger touch pattern by at least determining when the higher touch values define a complete ring.

12. The electronic device of claim 10 wherein said controller is configured to determine when the read touch values define an invalid single finger touch pattern by at least determining when the higher touch values define a partial ring.

13. The electronic device of claim 12 wherein said controller is configured to determine the partial ring based upon a first region of the array of finger touch sensitive areas having the lower touch values not lying completely within a second region of the array of finger touch sensitive areas having the higher touch values.

14. The electronic device of claim 12 wherein said controller is configured to determine the partial ring based upon corner areas of a first region of the array of finger touch sensitive areas having the lower touch values not lying completely within a second region of the array of finger touch sensitive areas having the higher touch values.

15. The electronic device of claim 10 wherein said controller is configured to not perform the finger separation determination when the read touch values define the valid single finger touch pattern.

16. A method for operating an electronic device comprising a touchscreen having an array of finger touch sensitive areas, and a controller coupled thereto, the method comprising:
operating the controller to read touch values from the array of finger touch sensitive areas; and
operating the controller to determine when the read touch values define a valid single finger touch pattern having lower touch values within adjacent higher touch values, and, if so, treating the read touch values as being representative of a single finger touch, and, if not, causing a finger separation determination.

17. The method of claim 16 further comprising operating the controller to determine when the read touch values define the valid single finger touch pattern by at least determining when the higher touch values define a complete ring.

18. The method of claim 16 further comprising operating the controller to determine when the read touch values define an invalid single finger touch pattern by at least determining when the higher touch values define a partial ring.

19. The method of claim 18 further comprising operating the controller to determine the partial ring based upon a first region of the array of finger touch sensitive areas having the lower touch values not lying completely within a second region of the array of finger touch sensitive areas having the higher touch values.

20. The method of claim 18 further comprising operating the controller to determine the partial ring based upon corner areas of a first region of the array of finger touch sensitive areas having the lower touch values not lying completely within a second region of the array of finger touch sensitive areas having the higher touch values.

21. The method of claim 16 further comprising operating the controller to not perform the finger separation determination when the read touch values define the valid single finger touch pattern.
